(19) United States
(12) Patent Application Publication
(10) Pub. No.: US 2018/0167198 A1
(43) Pub. Date: Jun. 14, 2018

(54) TRUST ENABLED DECENTRALIZED ASSET TRACKING FOR SUPPLY CHAIN AND AUTOMATED INVENTORY MANAGEMENT

(71) Applicant: Cisco Technology, Inc., San Jose, CA (US)

(72) Inventors: Justin J. Muller, San Jose, CA (US); Carlos M. Pignataro, Raleigh, NC (US); Rajiv Asati, Morrisville, NC (US); Nagendra Kumar Nainar, Morrisville, NC (US)

(21) Appl. No.: 15/482,043

(22) Filed: Apr. 7, 2017

Related U.S. Application Data
(60) Provisional application No. 62/432,066, filed on Dec. 9, 2016.

(51) Int. Cl. H04L 9/06; G06F 21/16

(52) U.S. Cl. CPC H04L 9/0637; G06F 21/16; G06F 2221/0737; H04L 2209/603; G06Q 2220/18

(57) ABSTRACT

A system for decentralized tracking of assets (devices (hardware) or software) is provided. One or more servers are configured to execute blockchain software for a blockchain that tracks ownership and usage of devices or software. Each transaction in the blockchain includes an asset identifier that identifies a particular device or instance of software and an owner identifier that identifies a particular owner of a particular device or instance of software. One or more computing devices are configured to run a blockchain client application that communicates with the blockchain software to provide updates to the blockchain as to ownership and usage of devices or software. The blockchain client application configured to add a new transaction to the blockchain to specify a new owner identifier when upon a sale/transfer and to specify when an update or change is made to a particular device or instance of software.

### PRIORITY CLAIM

This application claims priority to U.S. Provisional Application No. 62/432,066, filed Dec. 9, 2016, the entirety of which is incorporated herein by reference.

### TECHNICAL FIELD

The present disclosure relates to tracking of hardware and/or software assets.

### BACKGROUND

It can be difficult to prevent illegal transfer of assets to the grey and black markets. Examples of assets include computing equipment, network equipment, software or any other hardware (e.g., device or thing) that may involve technical support. For support engineers, there is no technology available that can provide visibility into the chain of ownership, and various lifecycle data, which makes support challenging.

### BRIEF DESCRIPTION OF THE DRAWINGS

FIG. 1 is a block diagram of a trust-enabled decentralized system to track ownership of usage of hardware and/or software assets using a blockchain, according to an example embodiment.

FIG. 2 is a diagram illustrating a high-level operational flow of the system depicted in FIG. 1, according to an example embodiment.

FIG. 3 is a diagram illustrating operational flow of the system depicted in FIG. 1, according to another example embodiment.

FIG. 4 illustrates data involved in a blockchain transaction to support the tracking system and method, according to an example embodiment.

FIG. 5 is a diagram of a system that includes servers in different enterprise networks configured to implement nested blockchains in order to track assets, according to an example embodiment.

FIGS. 6A-6F are diagrams illustrating example operations of the system depicted in FIG. 5, according to an example embodiment.

FIG. 7 is a block diagram of a blockchain server configured to participate in the trust-enabled decentralized asset tracking system and method, according to another example embodiment.

FIG. 8 is a block diagram of a device (hardware) configured to participate in the trust-enabled decentralized asset tracking system and method, according to another example embodiment.

### DESCRIPTION OF EXAMPLE EMBODIMENTS

### Overview

In accordance with one embodiment, a system is provided for decentralized tracking of assets (hardware or software). One or more servers are configured to execute blockchain software for a blockchain that tracks ownership and usage of devices (hardware) or software, such that each block in the blockchain includes an asset identifier that identifies a particular device or instance of software and an owner identifier that identifies a particular owner of a particular device or instance of software. The blockchain software is configured to create a new transaction in the blockchain for a newly created device or instance of software and to include an asset identifier for the newly created device or instance of software together with an owner identifier to whom the newly created device or instance of software is sold or transferred. One or more computing devices are configured to run a blockchain client application that communicates with the blockchain software to provide updates to the blockchain as to ownership and usage of the asset. The blockchain client application is configured to add a new transaction to the blockchain to specify a new owner identifier when a particular asset is sold or transferred and to specify when an update or change is made to a particular asset.

### Detailed Description

### Trust Enabled Decentralized Asset Tracking for Supply Chain

Presented herein is a system and method that uses blockchain technology as a data tracking tool covering chain of ownership and change/update information. This can be useful for support engineers, as an example. As used herein, an asset may be a piece of hardware (a physical device or thing) or (an instance of) software.

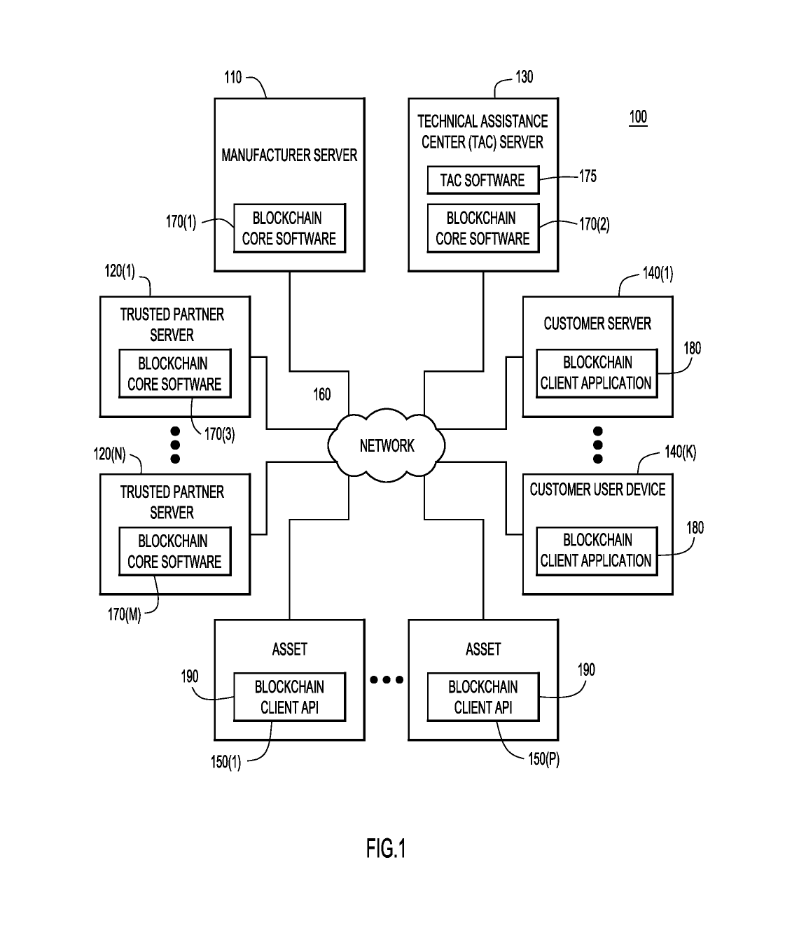

Referring first to FIG. 1, a trusted-enabled decentralized asset tracking system 100 is shown. The system 100 includes a manufacturer server 110, one or more trusted partner servers 120(1)-120(N), a technical assistance center (TAC) server 130, one or more customer server and customer user devices 140(1)-140(K), and a plurality of (hardware) devices or software instances (e.g., assets) 150(1)-150(P). While only a single manufacturer server 110 is shown, this is by way of example, and it should be understood that there may be a plurality of manufacturer servers. Communication among these elements is by way of network 160. Network 160 may be any combination of private and public local area networks and wide area networks (both wired and wireless), including the public Internet. The manufacturer server 110, trusted partner servers 120(1)-120(N) and TAC server 130 run instances of blockchain core (server) software 170(1)-170(M) for a blockchain. The TAC server 130 also runs TAC software 175.

The instances of the blockchain core software 170(1)-170(M) enable different entities to have access and control to a blockchain that stores data which tracks information about assets, 150(1)-150(P), ultimately to provide visibility into that information when a service or support issue is presented about an asset to a TAC entity. Thus, as explained in more detail hereinafter, the instances of the blockchain core software 170(1)-170(M) provide access to the blockchain above and beyond that permitted by a customer server or customer user device.

The customer servers and user devices 140(1)-140(K) run a blockchain client application 180. The blockchain client application 180 allows a customer to upload information about an asset to the blockchain, but without permissions to view other nodes/blocks in the blockchain or to alter the blockchain in any way. Similarly, some devices, called “smart” devices, have sufficient computing and connectivity capabilities, and therefore may run a blockchain client application programming interface (API) 190 that enables the device to upload data about changes to the device to the blockchain.

The assets 150(1)-150(P) may be any physical device that may or may not include software. In some instances, the assets may have sufficient computing and connectivity capabilities that they may run the blockchain client API 190, but not always. Thus, while FIG. 1 shows that assets 150(1)-150(P) include computing capabilities to run the blockchain client API, this is not meant to be limiting as there may be numerous devices that do not have such capabilities. Moreover, the assets may be entirely one or more software program instances,

A blockchain is a public ledger mechanism, and as used herein, it lists the owners of each asset. A blockchain is also a distributed system, using cryptographic methods to ensure that each transfer of assets is valid. According to the techniques presented herein, the blockchain is used to ensure that each asset (a manufacturer's product, for example) is being used only by its registered owner. The blockchain also tracks certain usage and change information about the asset.

The blockchain configuration used in accordance with the methods presented herein is a partially private permissioned blockchain with encrypted data blocks, as described below. This creates trust among a manufacturer's channel partners, resellers, and customers because there is a single public, fault tolerant, tamper resistant source of truth which allows for verification that each transaction is legal, and each asset is an authentic product. It also gives a manufacturer's services and other authorized service providers insight into the entire chain of custody for a particular asset, as well insight into the asset's specific usage information.

In order to properly realize the benefits of the blockchain as used herein, a large number of partners run an instance of the blockchain, as shown by the trusted partner servers 120(1)-120(N) in FIG. 1. A manufacturer may incentivize others to run instances of the blockchain, and can do so in different ways. As one incentive, partners are able to search on the blockchain, although identity and usage data will be hidden by way of encryption. Incentivizing others to run the blockchain may be worthwhile because many instances of blockchain running will better ensure security and prevent any one user or group of users from tampering with the system.

A blockchain transaction involves two components: (1) a unique way of identifying the user/owner, and (2) a unique way of identifying the asset. For this submission, both hardware and software are considered “assets” and the word “asset” refers to either one. Various identification methods are presented herein, and all create a unique asset identifier (ID) used to specifically refer to a single asset.

Hardware Identification

For hardware, a number of methods of unique identification are possible. Each silicon chip has a unique count and pattern of closed broken transistors which generally are turned off during fabrication and forgotten about. However, this pattern could be used as a unique silicon fingerprint for each piece of hardware. Depending upon the application, it may also be possible to add a sticker with a built-in identifier (ID), such as a radio frequency ID (RFID) chip, which has the wiring built into the sticker itself in such a way that the chip is destroyed if someone attempts to tamper with or remove the sticker. Tamper resistant hardware authentication modules also exist that can be built into a device to provide a unique ID. Other methods may be used for hardware identification. In addition, some methods may identify the hardware and software together as a single asset. Likewise, there are other methods that may be used for issuing keys for identifying users.

Software Identification

For software, the program itself can be compiled containing a random string which is randomized at the time the program is compiled. After compiling, a hash is taken of the code, which creates a unique identifier for that piece of software. This means that every single copy of software needs to be recompiled for every customer, but it also means that each copy is completely unique. Other software serialization methods also exist and may be used.

Customer Identification

In the case of identifying the user, one method is to issue to each user a personal private key file, using the standard public/private key pair method. This creates a “permissioned” blockchain, because all users need “permission” from the blockchain owner, in this case the manufacturer, in order to register transactions on the blockchain. The manufacturer may also delegate the ability to add users to the chain, so that certain trusted partners can also give permission for new users by issuing private keys.

The customer is incentivized to keep this key private because anyone with the key could assume ownership of the associated assets. The key itself can be stored either with the customer, or stored by the manufacturer or partner as a service to a customer. This makes it difficult for users to transfer ownership without registering the transfer. If they simply give physical ownership of an asset to another party, that party would need either to register ownership with their own private key, or else have a copy of the private key of the original owner. However, the original owner would never want to share their private key, as it would open them up to having all their assets stolen.

Permission Layers

The blockchain also has multiple layers of permissions, both created and maintained by the manufacturer, for example. The manufacturer can also share and delegate this authority to trusted partners. These permission layers are part of what makes the blockchain techniques presented herein different from a standard blockchain. Although it is not shown in FIG. 1, the permission lists are actually stored in the blockchain, and only the manufacturer, in this example, can change or add to the permission lists.

The following table summarizes who can access what portions of the blockchain.

| | Access to | Access to Chain of | Access to Data |
|---|---|---|---|
| User | blockchain | Ownership | Blocks |
| General Public | None | None | None |
| General Customers | limited | Limited to their own | Limited to their |
| | | assets | own assets |
| Trusted Partners | Partial | All (anonymized) | None |
| Manufacturer | All | All | All |

The first permission layer is a list of users who are allowed to be part of the consensus algorithms, effectively validating transactions by running instances of the blockchain. These users are the manufacturer and trusted partners. The first permission layer prevents a hacker from spinning up multiple instances of the blockchain, and therefore controlling a majority of the instances. In a traditional blockchain, this layer is not used because there are so many instances that a bad actor would need to own more computers than there are on the planet to spin up a majority of the system. However, the blockchain presented herein will not be able to rely on quantity to prevent this kind of attack, therefore it is desirable to limit instances to trusted partners and larger customers. In addition, only users at this level of permission will have a copy of the entire blockchain, allowing only users at this level to have visibility into the chain of ownership for every asset. These users still would not be able to read the data blocks, unless they are given the blinding (private) key for specific blocks by either the manufacturer or the owner of the asset. These users would also not have access to the actual identity of the owners, because they would see the public keys, but only the manufacturer has access to the data from which the private key was issued, which ties the public key to things like name and contact information. More information about the data blocks and blinding keys is described below.

The second layer of permission is a list of parties allowed to make new transactions. This layer is basically a list of everyone with permission to own something from the manufacturer. To be put on this list, a user needs to register with the manufacturer or one of the manufacturer's delegated providers. Registration may include things like name, location, contact information, and financial information which is useful for verifying identity. This also prevents an unknown or illegal entity from taking possession of a manufacturer's asset without at least identifying himself/herself. Even if an entity provides false identification, all users will know that someone with false identification took possession, which in itself can be useful information. In addition, users at this level can see the chain of ownership for the asset they own, but only the data blocks which were published when they actually owned the asset.

Blinding Key Data Block

While the blockchain is a public ledger, each entire transaction is actually not public. Instead, in addition to the basic required transaction information there is also a data block which is encrypted and cannot be read by the public. The data block is only accessible using a blinding key (private encryption key), which would be held by the appropriate parties. The blinding key would be issued to the customer at the same time as their private key, but the manufacturer would retain a copy of the blinding key as well. This allows the customer to view their own data, but allows the manufacturer to also view the data if the customer so permits. The manufacturer can also delegate the ability to use the blinding key, while the customer cannot. This helps ensure that things like system troubleshooting that is best done using the data blocks will be accessible only by manufacturer-approved services. The data block may include things like device ID serial number (S/N), geolocation etc. The data block may also include a list of other asset IDs which are associated with the current asset. For example, the data block of a larger server would have the cards installed in that server as associated IDs, and the cards would have the server's ID in their data block. This data would be required to be published upon transfer, and would be updated by adding a self-transfer to the blockchain every time the ownership is validated. The current owner can only read data blocks for which they have the blinding key, which is likely only their own information. There may be more than one key issued for the encrypted section, as needed, so that whoever is creating that data block can give varied access to parts of it. In general, there may be one key.

Asset Transfer

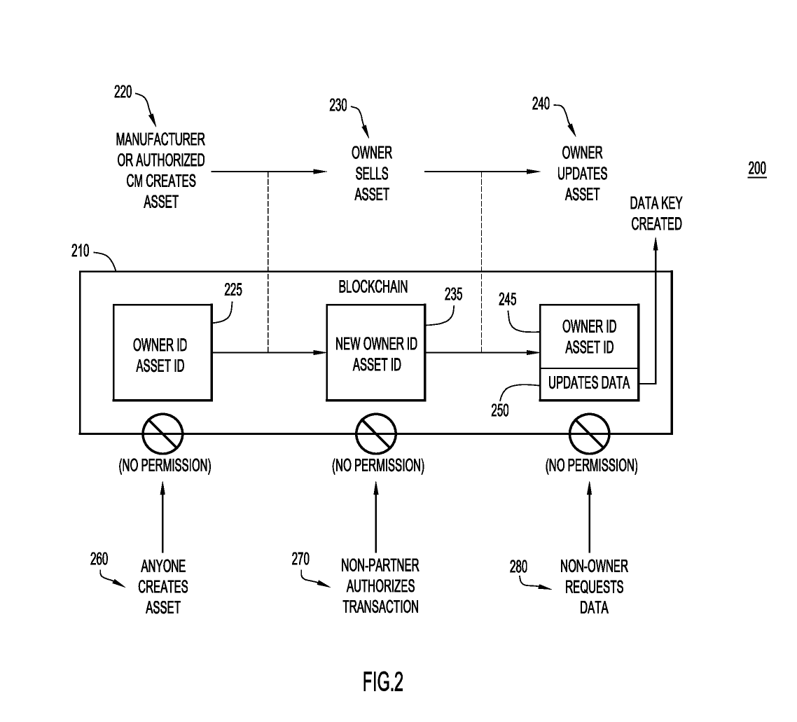

Reference is now made to FIG. 2. FIG. 2 is a pictorial representation of the blockchain and related process 200. The blockchain is shown at reference numeral 210. The top part of FIG. 2 illustrates authorized/permitted transactions, while the bottom part of the figure illustrates unpermitted transactions. At 220, the manufacturer or authorized contract manufacturer (CM) creates an asset. This entity has software to run the blockchain, and it creates a transaction 225 that includes an Asset ID and an Owner ID of the customer owner of the asset to which the manufacturer or authorized CM sells the asset. Next, the original customer owner of the asset sells the asset at 230, and a new transaction 235 in the blockchain is created that includes the New Owner ID and the Asset ID.

At a regular (periodic or non-periodic) interval, the asset will retransfer itself to its current owner by creating a new transaction. The transaction will be signed by the current owner's private key for both the previous and new owners, and will include a new updated data block. If the transaction fails, the assets will no longer function, or will revert to a demonstration mode as appropriate until a successful ownership transaction can be made.

Transferring an asset tracked with the blockchain 210 involves a few different aspects. First, the Asset ID, which is unique to the asset. Second, the transaction is signed by the previous owner using their private key, and then also signed by the new owner using their private key. Both private keys are issued by the manufacturer or a delegated partner (authorized CM), to insure the user has permission to receive and use the asset. In addition, at the time of transfer, certain data about the new owner is stored in a hidden data block of the transaction. This includes things like geo-location, current software stack version, and usage statistics.

In addition to creating a new transaction at regular intervals to make sure the asset is still being used by the correct (registered) owner, assets will also create a new transaction whenever a significant software update is performed, for example. This is shown at 240 in FIG. 2, and the transaction 245 is created, either in response to a notification sent by the asset via a blockchain API or by a customer using a blockchain client application (as described above in connection with FIG. 1). This creates a complete history of what updates were performed when, stored securely in the blockchain itself and only accessible by the customer and the manufacturer or its delegates. As described above, certain data in the transaction 245 may be encrypted by a customer's key so that the data is hidden in the transaction, including information like geo-location, software stack version and usage statistics. This encrypted data is shown at reference numeral 250, which is part of the transaction 245.

Asset Tracking—Chain of Ownership and Data Blocks

When a service request is made for a particular asset, the Asset ID is included in the request. This allows the service engineer to look up the chain of ownership in the blockchain by preforming a search on that Asset ID. The engineer can also look up the blinding keys in its internal database, and use that key to view the data blocks in the entire chain of ownership. This data provides critical value in understanding how to address problems with the asset. In addition, only the manufacturer and its delegated partners can perform this search and use the blinding keys, unless the customer decides not to allow that in some situations. This creates a major competitive advantage over unauthorized service providers who will not have access to this data.

The bottom of FIG. 2 shows several examples of access to the blockchain that are not permitted according to the techniques presented herein. Reference numeral 260 indicates that not just anyone can create an asset on the blockchain. If just anyone were to try create an asset on the blockchain, even if they had the blockchain client application, they would not have sufficient permissions to create an asset on the blockchain. Reference numeral 270 indicates that a party that is not a partner tries to gain access to the blockchain 210 (either by hacking blockchain software, theft of the blockchain software or posing as a blockchain node), they would not be permitted access because they would not have sufficient permissions to operate on the blockchain. Reference numeral 280 indicates that a non-owner cannot gain access to data in a transaction because they do not have the appropriate key and also do not have sufficient permissions to operate on the blockchain, like the manufacturer or partners. The situation indicated by reference numeral 280 may occur if an unauthorized third-party service entity wanted access to the data of a transaction in the blockchain in order to service an asset.

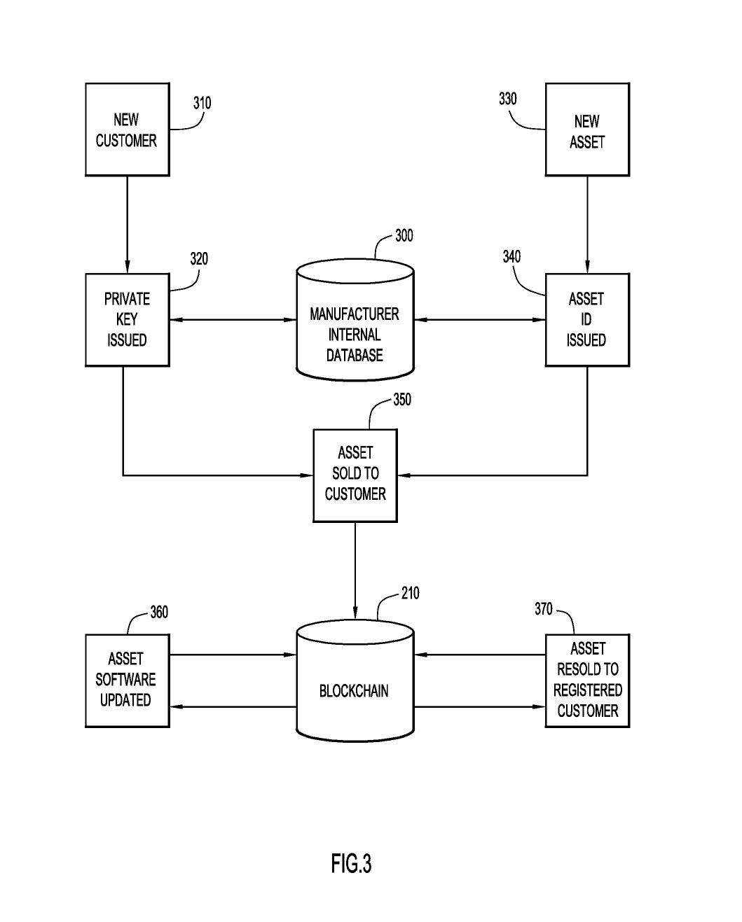

FIG. 3 illustrates another view of the operational flow. In this figure, an internal database 300 (maintained by the manufacturer, for example) is shown that is used to store various keys used by entities to update blocks in the blockchain 210. On top left of FIG. 3, operations 310 and 320 are performed when a new customer is to be sold an asset. At 320, a private key (also referred to herein as the blinding key) is issued to the new customer, and this private key is stored in the database 300. On the top right of FIG. 3, a flow is shown when a new asset is to be added to the blockchain. At 330, a new asset is created or allocated and an Asset ID is issued for the asset (using any of the techniques described above) at 340. At 350, the asset is sold to a customer and a transaction is added for the blockchain 210 for this event. As shown at 360, when asset software is updated, a transaction is added to the blockchain for that even and related information summarizing that event. Similarly, as shown at 370, when an asset is resold/retransferred to a registered customer to record some other updating event associated with the asset, to create a transaction in the blockchain for that event.

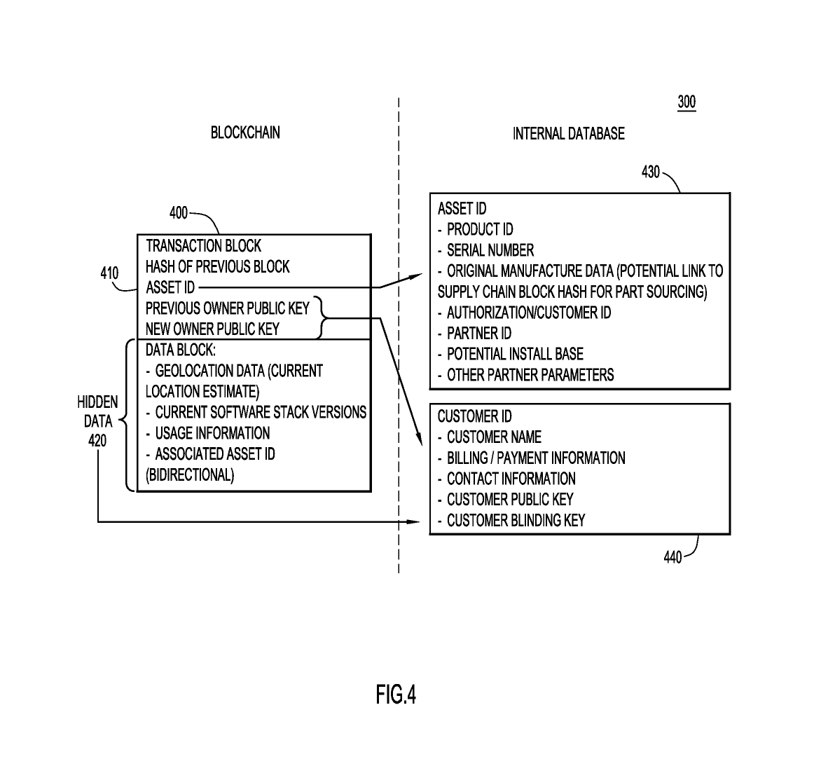

Reference is now made to FIG. 4. FIG. 4 shows examples of content in a blockchain block 400 and in the internal database 300. A block 400 of the blockchain includes a transaction block portion 410 and a data block portion 420. A block is a group of several transactions. The transaction block portion 410 includes: a hash of a previous transaction, and Asset ID, previous owner's public key, and new owner's public key. The transaction block portion 410 is visible to anyone who has access to the blockchain. Examples and forms of the Asset ID are shown at 430, and the Asset ID is also stored in the manufacturer's internal database 300, or the Asset ID may be tied to all of this information stored in the database 300. Likewise, the customer (owner) ID is stored in the internal database 300, as shown at 440, and includes a customer name, billing/payment information, contact information, the customer public key and the customer blinding key. The customer blinding key is needed to view information in the data block portion 420 because this data is kept hidden (encrypted) based on the blinding key. Examples of data in the hidden data block portion 420 include: geographic location data (e.g., a current location estimate of the asset), current software stack versions installed and running on the asset, and usage information about the asset.

The system and methods described above in connection with FIGS. 1-4 is designed to track ownership and use of assets. This is useful to gain visibility into a product install base for use by services or support entity to have an understanding of how products are used in order to better service the products. Product usage includes who owned the product, where, when, and any major changes made to the product. The systems and methods presented herein may be used to track history and the identities of people/organizations that were involved in “touching” the product or software in any way, including making changes, enhancements/upgrades, replacements of parts, etc., regardless of transfer of ownership of the product. This system and method does not attempt to prevent black market activity, but instead simply tracks it, and makes information available later to any entity that is interested in that information, such as a service/support entity. The multi-tiered permissions are opened enough that the black-market users may use the system, but closed enough that a product manufacturer still draws exclusive value from the data created.

The system and methods presented herein combine a permission-less blockchain (which has no centralized administration) with a database in which administrators have authority and power. The mix of the permissions is made in order to obtain get benefits of blockchain (security and immutability) without completely giving up control, by retaining permissions on certain portions of the abilities of the blockchain.

As explained above, the blockchain used herein is configured to limit who can view the private data and who has access/ownership to the data blocks in the blockchain. In order preserve security and prevent someone from taking over the blockchain, restrictions are made as to who can be a blockchain node by running the blockchain software. This is limited to a particular group: the manufacturer and its “trusted partners”.

The blockchain system also supports legal partners and resellers of a manufacturer's technology, in a way that prevents illegal copying. For example, if a verified owner wants to sell their asset, they can create a transaction in the blockchain which identifies them as the current owner, and then includes the public key of the new owner. The effectively transfers ownership, deactivating any instances from the old owner, and allowing the new owner to immediately activate their asset.

There are several advantages to this solution, and the following are examples of advantages. The solution creates trust that a manufacturer or product vendor cannot accidently corrupt or mishandle data, by making the data transparent (publicly available in a known way). It creates trust by ensuring robust fault and tamper resistant data. It creates visibility for a manufacturer into asset chain of custody of assets, including technical details, improving service capabilities. It prevents use of assets by people not registered with the manufacturer. The solution also a creates competitive advantage for services because only the manufacturer and authorized parties can search on and see chain of custody and other historic usage data such as software updates.

### Automated Inventory Management to Curb Illegal Asset (Hardware) Use

Hardware/device/equipment manufacturers face challenges in controlling and handling illegal hardware transactions in grey market and software licensing. Equipment support services is a multi-billion dollar industry, often supported through improper and illegitimate use of hardware. It is difficult to track and differentiate legal/illegal distribution of products or the integrity of the legitimate users. In simple words, the goal is to limit and track downloads of software being used to compete against a manufacturer. In one example, there are electronic vendors in illegal black market who can get faulty equipment, fix it and re-sell it. There is no way to identify if the customer got the product from a true or authorized manufacturer or from the black market as a refurbished product.

Along the same lines, software licensing has been known to be problematic to implement/enforce. Additionally, as network functions get virtualized (e.g. selling only router software), it becomes more difficult and important to streamline the software licensing.

In accordance with an embodiment, a blockchain-based approach is used to tackle these challenges. A (single/multiple user/device) validation approach leverages blockchain where relevant details could be uploaded into the blockchain ledger for 2 subsequent usages—1) verification whenever the device comes up (or a periodic verification every X period of time), and 2) identification of any illegitimate transactions for future verifications. Leveraging blockchain is further extended to let go of “licensing” and rather leverage blockchain concepts for authorizing the software usage.

There are embodiments described below to address/cover certain scenarios in which: (a) a manufacturer's products that have reachability to the blockchain for validation, (b) a manufacturer's products that do not have reachability to the blockchain for validation, and (c) a hybrid model.

As described above, blockchain involves two components, a unique way of identifying the user/owner, and a unique way of identifying the asset. In the case of identifying the user, one method is to issue each user a personal private key file. The user is incentivized to keep this key private because anyone with the key could assume ownership of the associated assets. The key itself can be stored either with the customer, or stored by the manufacturer or a partner as a service to the customer.

To uniquely identify the asset, there is a different approach depending upon whether the asset is hardware or software. For software, the program itself can be compiled containing a random string which is randomized at the time the program is compiled. After compiling, a hash is taken of the code, which creates a unique identifier for that piece of software. This means that every single copy of software needs to be recompiled for every customer, but it also means that each copy is completely unique.

For hardware, a number of methods of unique identification are possible. Each silicon chip has a unique count and pattern of closed transistors which generally are turned off during fabrication and forgotten about. However, this pattern could be used as a unique silicon fingerprint for each piece of hardware. Depending upon the application, it is also possible to add a sticker with a built in ID, such as an RFID chip, which has the wiring built into the sticker itself in such a way that the chip is destroyed if someone attempts to tamper with or remove the sticker.

The term asset refers to, but is not limited to, hardware or software, and the asset ID is the unique ID obtained for each asset, as described above.

In accordance with this embodiment, a manufacturer's devices (deployed in customer networks) communicate with the manufacturer's blockchain network via a proxy blockchain node deployed in the customer network itself. This allows for the notion of child blockchains and a parent blockchain.

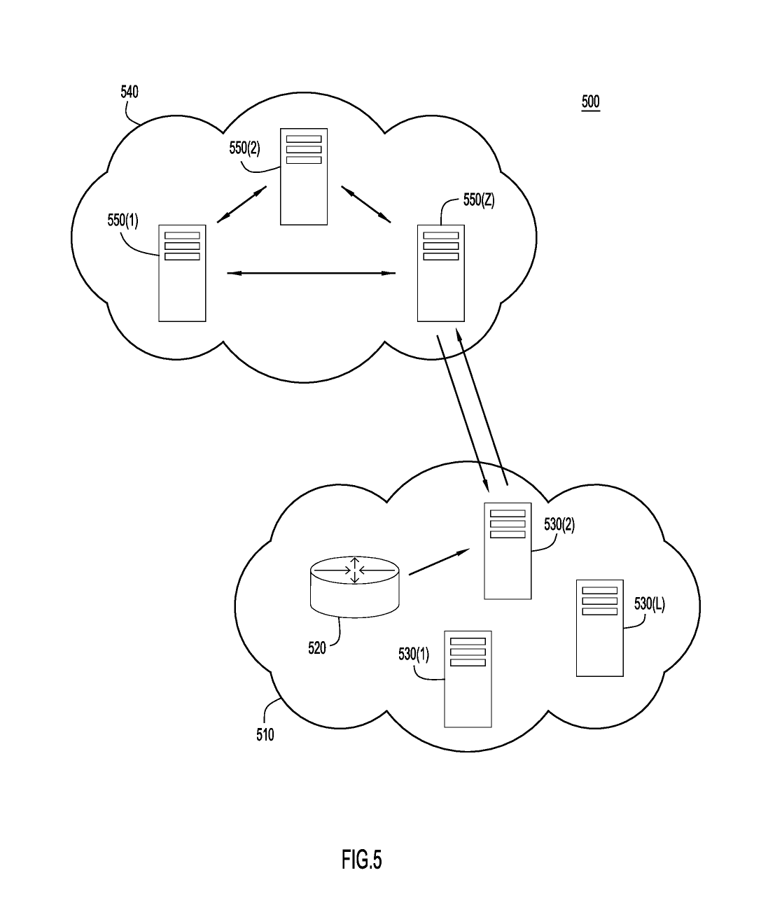

Reference is now made to FIG. 5. FIG. 5 shows a system 500 that includes a provider or partner network 510. The provider network includes one or more blockchain servers 530(1)-530(L). The system 500 also includes a manufacturer's network 540 that includes a plurality of blockchain servers 550(1)-550(Z).

The blockchain infrastructure consisting of blockchain servers 550(1)-550(Z)) hosted in the manufacturer's network 540 run one or more parent blockchains, whereas the provider blockchain servers 530(1)-530(L) may also host one or more blockchains which are linked in a nested fashion the one or more blockchains running on the one or more blockchain servers 550(1)-550(Z).

This allows devices to communicate and authenticate only with a blockchain running in a provider or partner network, which in turn is authenticated with a blockchain running in the manufacturer network. This allows a manufacturer's devices to be deployed in a secluded environment (as is the case with many network devices), not having direct network (Internet) access to the manufacturer's blockchain servers.

Upon manufacturing, each hardware device would be assigned an initial asset ID. Subsequently, as part of product supply chain, once the device is purchased by/to be shipped to the customer, an entry is created in the manufacturer blockchain which ties that customer ID to the asset ID. Additional information such as the purchase details (like product ID, authorization/customer ID, partner ID, other partner parameters, potential install base location etc.) may be added in the data portion of the blockchain transaction on a per-device basis, and which details are relevant only to a provider, for example. The transaction ID and asset ID will be embedded within the product and shipped to customer.

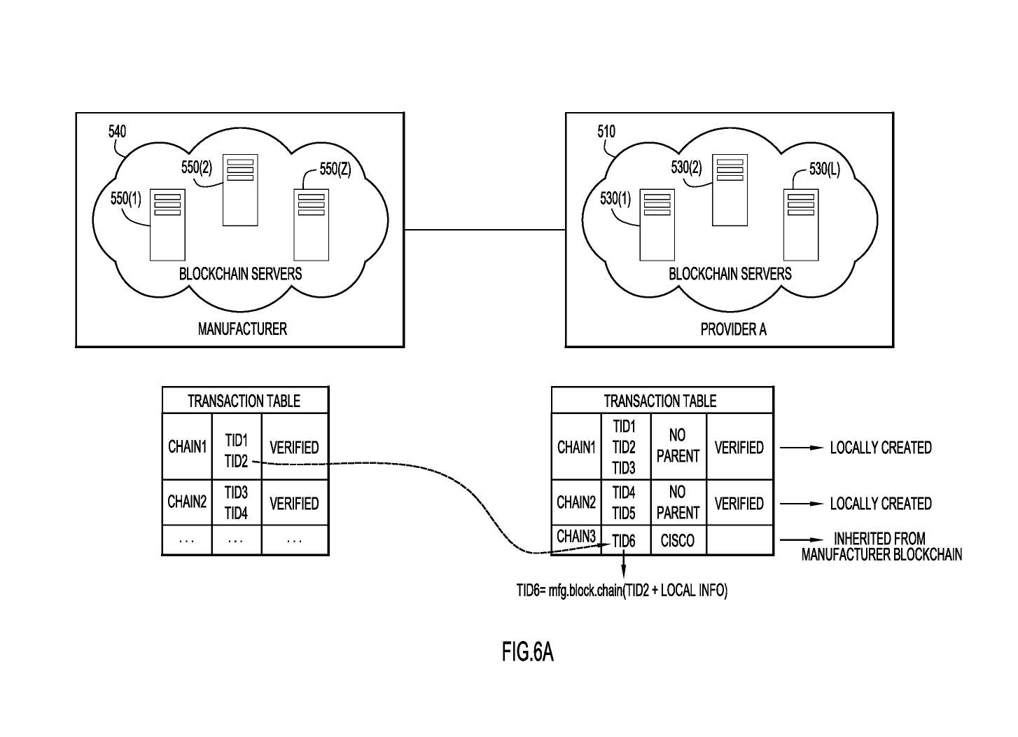

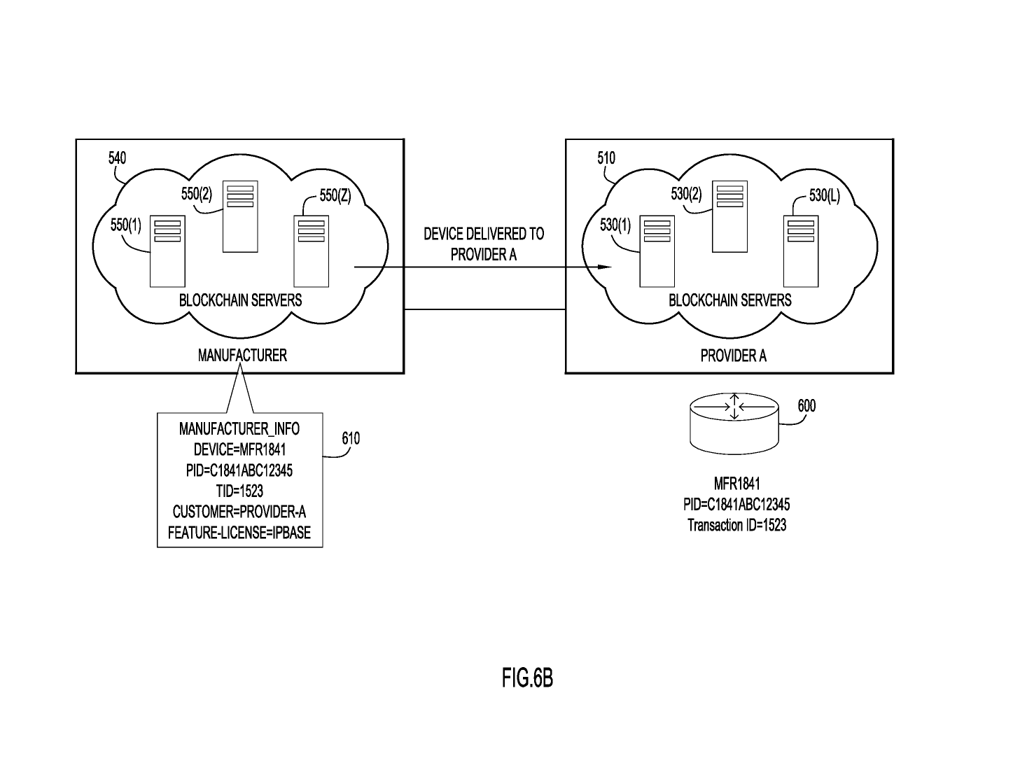

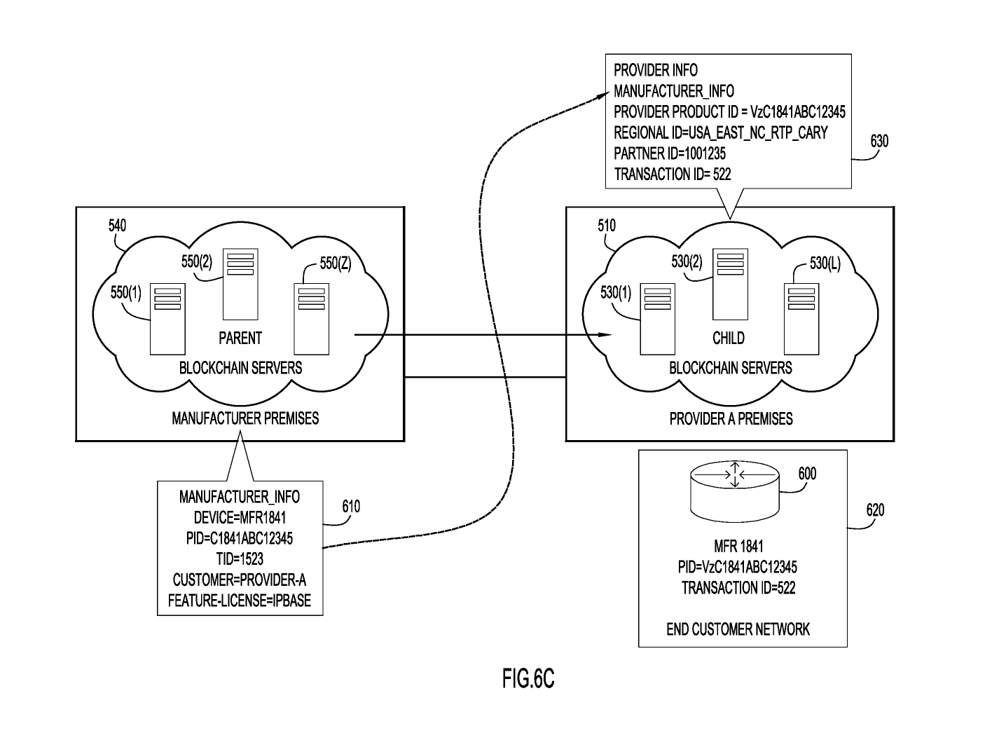

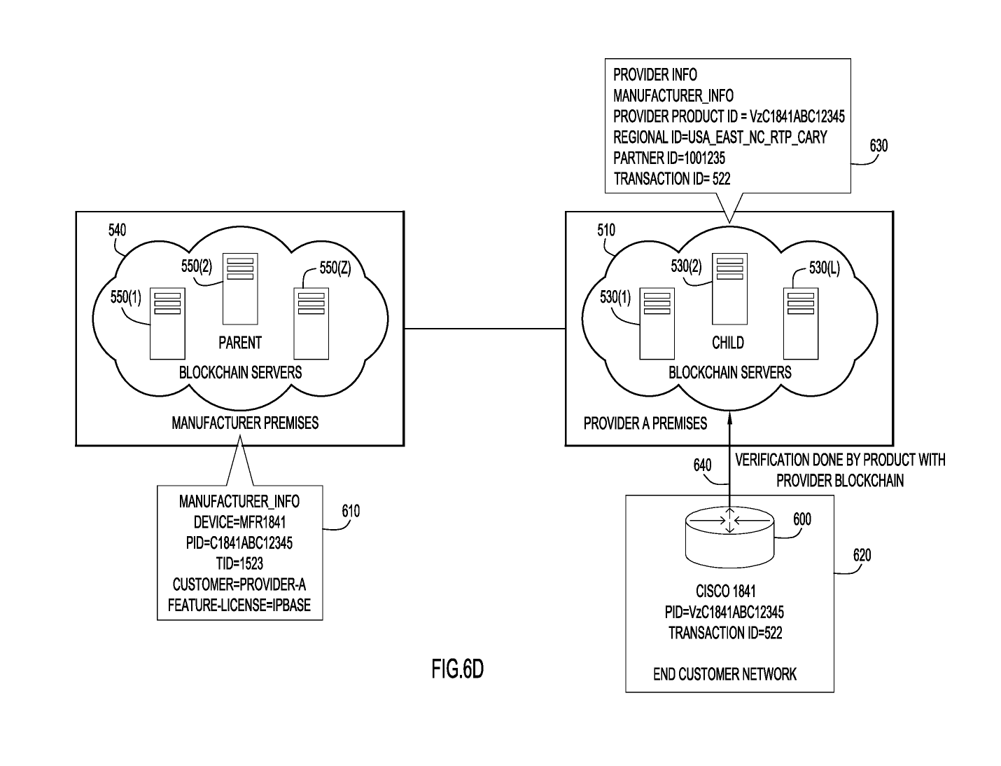

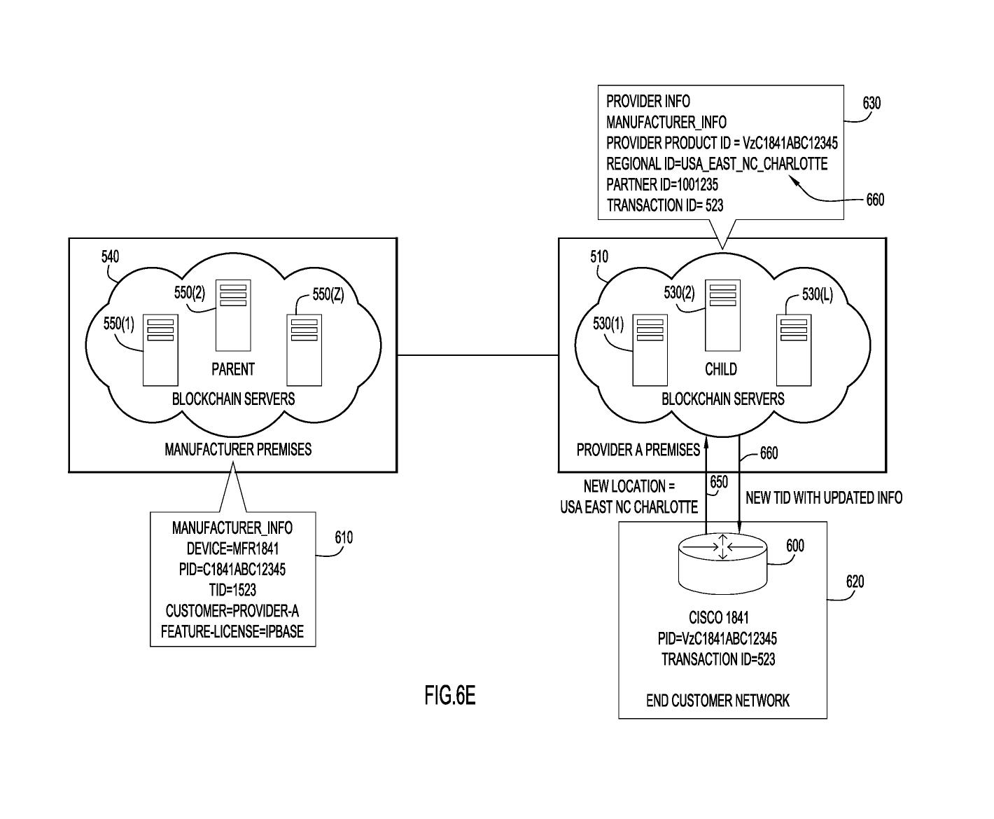

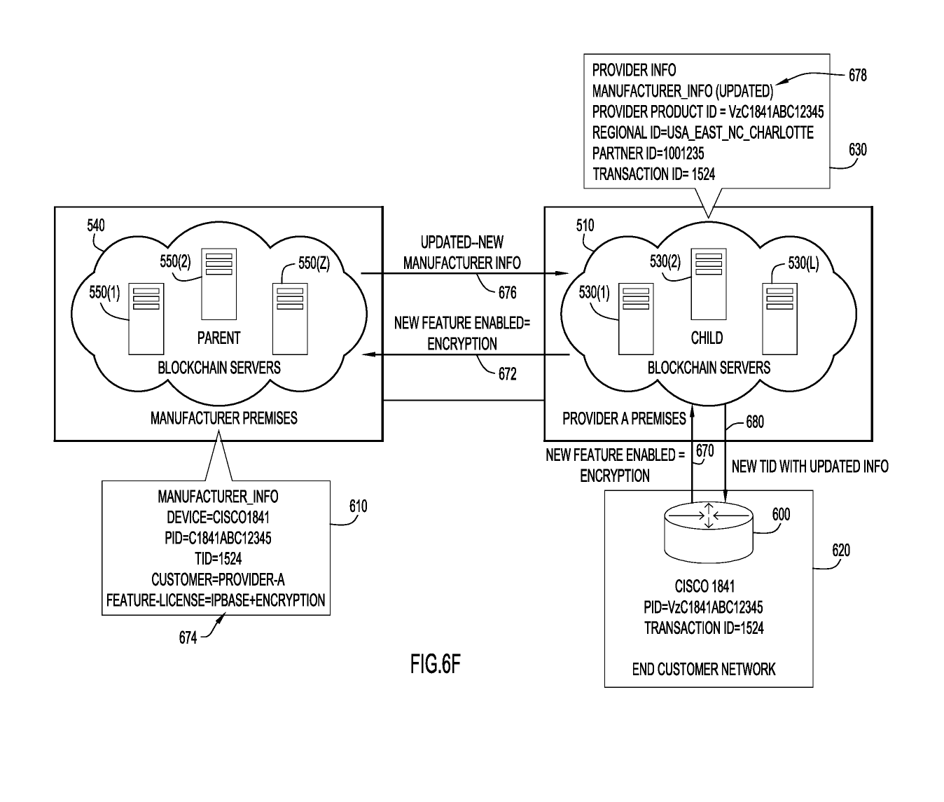

Reference is now made to FIGS. 6A-6F for a description of the operation of system 500, in accordance with an example embodiment. In FIG. 6A, the manufacturer sends a product, e.g., a network device, to a provider or partner, denoted Provider A that has a provider network 510 and one or more blockchain servers 530(1)-530(L). The manufacturer has one or more blockchain servers 550(1)-550(Z). One of the blockchain servers 550(1)-550(Z) creates a transaction identifier (TID) for this transaction, denoted TID2 in a blockchain maintained by the manufacturer. Similarly, upon receiving the product for installation at a customer site, one or more blockchain servers 530(1)-530(L) in the provider network 510 creates a transaction in one of the provider's local blockchains, and this transaction is identified by TID6. TID6 is created that references a transaction in one of the manufacturer's block chain, and TID6 includes additional local information (local_info) that in generally is only relevant to the provider. Whenever a change or update occurs in connection with the product that is not relevant to the manufacturer, information about that change or update is reflected in a provider blockchain, and not in the manufacturer blockchain. However, when information changes are made to the product that are specific to the manufacturer, that information change is provided to one of the manufacturer's blockchains. FIGS. 6B-6F illustrate an example of this.

FIG. 6B shows that a product/device 600, e.g., a network device, is delivered to Provider A. One of the manufacturer's blockchain servers is updated with the product details, and a TID is embedded within the non-volatile random access memory (NVRAM) of the product and shipped to Provider A. As shown at 610, the product details includes “Device=MFR1841”, “PID=C1841ABC12345” and the TID=1523. In addition, there is information that indicates the customer is Provider A and the feature license is a basic license (“IPBase”).

Turning now to FIG. 6C, Provider A maintains a local blockchain and offloads information from the manufacturer blockchain, and appends information in the local blockchain with local information about the product. For example, the Provider A installs the product/device 600 in an end customer network 620. As shown at 630, the provider updates its local blockchain with a transaction (TID=522) and including such “local” information such as a “Region ID=USA_East_NC_RTP_Cary” which reflects geolocation information of where the product is installed in the end customer network 620 and a Partner ID associated with that customer.

FIG. 6D shows at 640 that product verification is done by the product 600 with the provider blockchain, rather than with the manufacturer blockchain.

FIG. 6E shows an example of an information change about the product 600 that is only local in nature. In this case, an update is made to the provider blockchain only. At 650, the product 600 is moved to a new location in a customer's network, e.g., to Charlotte (from Cary). At 660, one of the provider blockchain servers 530(1)-530(L) updates the blockchain with a new transaction (TID=523) in which the geolocation information for the product has been changed to Charlotte. At 660, the new TID (523) is sent back to the product with the updated information for storage in the product. Again, since this change is only germane/relevant at the local level for the provider, it is kept at that level and no update is made to the manufacturer blockchain.

FIG. 6F illustrates an information change about the product that is relevant/specific to the manufacturer and thus is propagated to the manufacturer's blockchain servers. In this example, a new feature is enabled on the product, at 670, that affects the licenses associated with the product. For example, an encryption feature is enabled on the product. When this happens, the product 600 notifies one of the blockchain servers 530(1)-530(L) in the provider network 510. At 672, a communication is sent from the provider blockchain servers 530(1)-530(L) to the manufacturer blockchain servers 550(1)-550(Z) indicating that a new feature (Encryption) was enabled on the product 600. As shown at 674, one of the manufacturer blockchain servers 550(1)-550(Z) creates a transaction to reflect the feature license update for the product 600. At 676, one of the blockchain servers 550(1)-550(Z) sends a communication to one of the blockchain servers 530(1)-530(L) indicating that there has been an update to the manufacturer level information associated with product 600. At 678, one of the blockchain servers 530(1)-530(L) updates the local blockchain for the product 600 to indicate that there is a change in the manufacturer level information (e.g., license feature change), and associated TID. At 680, the new TID (TID=1524) is sent to the product 600 for storage therein with associated updated information.

Thus, according to the embodiment of FIGS. 5 and 6A-6F, a blockchain capability resides within a provider's network in the form of blockchain servers. These blockchain servers can receive a request for validation, uses the transaction ID and other details and attempt to resolve the query locally, or if that is not possible, send a query further to the manufacturer blockchain servers. Thus, the local blockchain servers serve as a proxy sitting in the customer premises with reachability to the blockchain servers of the manufacturer. The blockchain servers, being internal nodes to the customer provider network, will have reachability to all nodes within the provider network including infrastructure routers. On a demand basis, the provider's (child) blockchain servers may offload the selective chain for validation locally and update back with any new updates to the manufacturer's (parent) blockchain servers.

A very simple example on how a grey market transaction can be identified is as follows. A linecard sold to Service Provider SP-A with identification (like IP range of a.b.c.0/24) was sold to the black market on failure, and was refurbished and sold to service provider SP-B illegitimately. On boot up, the linecard will perform the validation with parent blockchain, which fails because the card is still registered with the original owner, and it will not work until the validation is success.

As another example, a linecard purchased by SP-A (and the contract expired) went faulty, and service provider SP-A tries to fix with a local non-registered vendor. Upon fix and bootup, the circuit fingerprint will be different, which fails to validate with the parent blockchain. This helps ensure that any product transaction is controlled by the manufacturer and helps control the grey market transaction. Any modification or refurbish done by a manufacturer-approved vendor will create a new fingerprint and/or asset ID and update the parent blockchain with new details for the relevant product. This helps with a successful validation upon device bootup.

This solution helps with inventory management, validation, using a trusted integrity platform (blockchain) in a controlled manner and helps to achieve “immutable record of lineage”. As mentioned above, one use case is a customer wants to make sure that refurbished hardware has been touched only by manufacturer-approved vendors and the lineage chain can help the customer verify that.

In summary, according to the embodiment depicted in FIGS. 5 and 6A-6F, a blockchain is used to automatically manage assets and prohibit the illegal usage of assets. This solution scales for any enterprise and/or service provider customers. It can achieve tamper-proof licensing. There is no license key to deal with, and therefore avoids associated license key issues. Every transaction is cryptographically secure and cannot be modified. It creates trust that a manufacturer cannot accidentally corrupt or mishandle data, creates trust by making the data transparent (publicly available in a known way), creates trust by ensuring robust fault and tamper resistant data, creates visibility for a manufacturer into asset chain of custody of assets, including technical details, improving service capabilities, and prevents use of assets by users not registered with the manufacturer.

The system of FIG. 5 and the methods depicted in FIGS. 6A-6F are one example use case for the basic system depicted in FIG. 1. The one or more blockchain servers shown in FIG. 1 may include a first set of one or more servers (e.g., servers 550(1)-550(Z) shown in FIG. 5) that reside in a first network, and a second set of one or more servers (e.g., servers 530(1)-530(L) that reside in a second network. At least one server of the second set of one or more servers is in communication with the particular device or instance of software to receive validation requests from the particular device or instance of software and send transaction validation responses to the particular device or instance of software, as depicted in FIG. 6D.

The first set of one or more servers run one or more blockchains that track a first class of transactions associated with usage information for the particular device or instance of software and the second set of one or more servers run one or more blockchains that track a second class of transactions associated with usage information for the particular device or instance of software. The first class of transactions track are globally relevant transactions (such as feature license) associated with usage of the particular device or instance of software and the second class of transactions are locally relevant transactions (such as geolocation of the asset) associated with usage of the particular device or instance of software. The second set of one or more servers send validation requests to the first set of one or more servers when a change for the particular device or instance of software is a globally relevant transaction. As depicted in FIGS. 5 and 6A-6F, the first set of one or more servers are in communication with the second set of one or more servers so as to link a transaction pertaining to the particular device or instance of software between a blockchain running on the first set of one or more servers and a blockchain running on the second set of one or more servers.

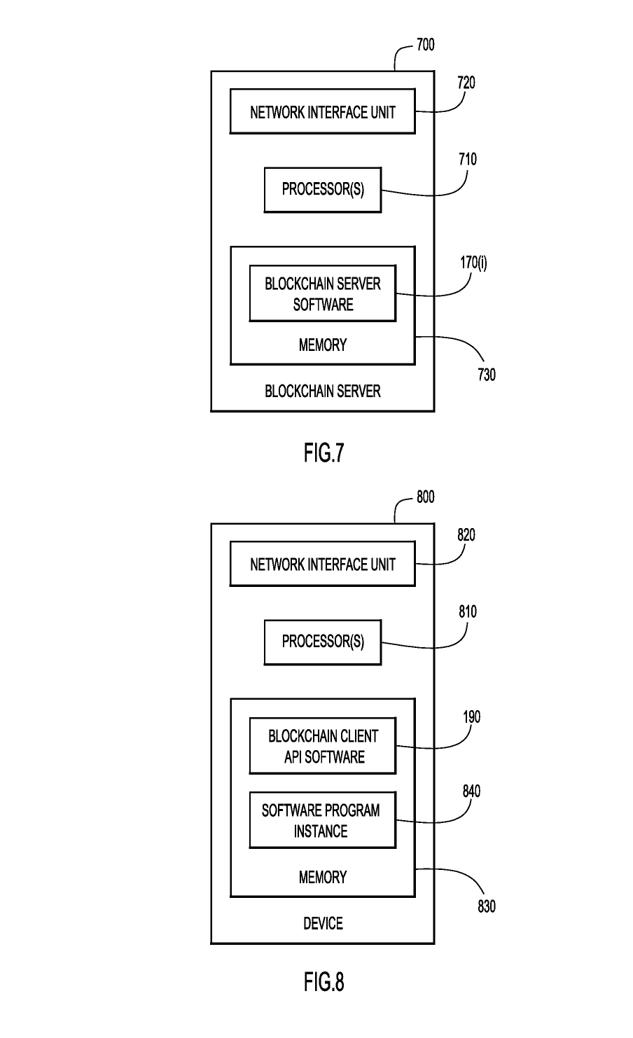

FIG. 7 shows a block diagram of a blockchain server 700 according to an example embodiment. This diagram is meant to represent any of the servers 110 and 120(1)-120(N) in FIG. 1, as well as any of the servers 530(1)-530(L) and 550(1)-550(Z) in FIG. 5. A blockchain server 700 includes one or more processors (e.g., microprocessors or microcontrollers) 710, one or more network interface units (e.g., network interface cards, switches, etc.) 720 to enable network communications, and memory 730 that stores blockchain server software generically indicated by reference numeral 170(i). The blockchain server software 170(i) enables the blockchain server 700 to perform the server side blockchain operations described herein.

FIG. 8 illustrates a simple block diagram of a device 800 that may be part of the trust solution presented herein. The block diagram of FIG. 8 is meant to be generically representative of any of the assets 150(1)-150(P) shown in FIG. 1 and device 520 shown in FIG. 5. The asset 800 includes one or more processors (e.g., microprocessors or microcontrollers) 810, one or more network interface units 820 to enable wired or wireless network communications, and memory 830 that stores blockchain client API software 190 and, in some forms, a software program instance 840 that is to be tracked/managed according to the techniques presented herein. The blockchain client API software 190 enables communication between the asset 800 and a blockchain server in connection with the various operations described herein. It is to be understood that the asset 800 may further include various other components, such as network processing hardware (application specific integrated circuits) in the case of a network device, or any other combination of hardware or software components that are used in a particular type of device that is to be tracked according to the techniques presented herein.

The memory 730 and 830 shown in FIGS. 7 and 8 may include read only memory (ROM), random access memory (RAM), magnetic disk storage media devices, optical storage media devices, flash memory devices, electrical, optical, or other physical/tangible memory storage devices. Thus, in general, the memory may comprise one or more tangible (non-transitory) computer readable storage media (e.g., a memory device) encoded with software comprising computer executable instructions and when the software is executed it is operable to perform the operations described herein.

To summarize, in one form, a system is provided comprising: one or more servers configured to execute blockchain software for a blockchain that tracks ownership and usage of devices or software, such that each transaction in the blockchain includes an asset identifier that identifies a particular device or instance of software and an owner identifier that identifies a particular owner of a particular device or instance of software, wherein the blockchain software is configured to create a new transaction in the blockchain for a newly created device or instance of software and to include an asset identifier for the newly created device or instance of software together with an owner identifier to whom the newly created device or instance of software is sold; and one or more computing devices configured to run a blockchain client application that communicates with the one or more servers to provide updates to the blockchain as to ownership and usage of devices or software, the blockchain client application configured to add a new transaction to the blockchain to specify a new owner identifier when a particular device or instance of software is sold and to specify when an update or change is made to a particular device or instance of software.

In another form, a computer-implemented method is provided comprising: running a blockchain on one or more servers configured track ownership and usage of devices or software, such that each transaction in the blockchain includes an asset identifier that identifies a particular device or instance of software and an owner identifier that identifies a particular owner of a particular device or instance of software; generating a new transaction in the blockchain for a newly created device or instance of software and including an asset identifier for the newly created device or instance of software together with an owner identifier to whom the newly created device or instance of software is sold; receiving from a blockchain client application running on one or more computing devices that communicates with the one or more servers updates as to ownership and usage of devices or software; and adding a new transaction to the blockchain to specify a new owner identifier when a particular device or instance of software is sold and to specify when an update or change is made to a particular device or instance of software.

In still another form, one or more non-transitory computer readable storage media are provided encoded with software comprising computer executable instructions and when the software is executed operable to perform operations comprising: running a blockchain on one or more servers configured track ownership and usage of devices or software, such that each transaction in the blockchain includes an asset identifier that identifies a particular device or instance of software and an owner identifier that identifies a particular owner of a particular device or instance of software; generating a new transaction in the blockchain for a newly created device or instance of software and including an asset identifier for the newly created device or instance of software together with an owner identifier to whom the newly created device or instance of software is sold; receiving from a blockchain client application running on one or more computing devices that communicates with the one or more servers updates as to ownership and usage of devices or software; and adding a new transaction to the blockchain to specify a new owner identifier when a particular device or instance of software is sold and to specify when an update or change is made to a particular device or instance of software.

In yet another form, an apparatus is provided comprising: a network interface that enables network communications; a memory; one or more processors coupled to the network interface and to the memory, wherein the one or more processors are configured to: run a blockchain on one or more servers configured track ownership and usage of devices or software, such that each transaction in the blockchain includes an asset identifier that identifies a particular device or instance of software and an owner identifier that identifies a particular owner of a particular device or instance of software; generate a new transaction in the blockchain for a newly created device or instance of software and including an asset identifier for the newly created device or instance of software together with an owner identifier to whom the newly created device or instance of software is sold; receive from a blockchain client application running on one or more computing devices that communicates with the one or more servers updates as to ownership and usage of devices or software; and add a new transaction to the blockchain to specify a new owner identifier when a particular device or instance of software is sold and to specify when an update or change is made to a particular device or instance of software.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A system comprising:
one or more servers configured to execute blockchain software for a blockchain that tracks ownership and usage of devices or software, such that each transaction in the blockchain includes an asset identifier that identifies a particular device or instance of software and an owner identifier that identifies a particular owner of a particular device or instance of software, wherein the blockchain software is configured to create a new transaction in the blockchain for a newly created device or instance of software and to include an asset identifier for the newly created device or instance of software together with an owner identifier to whom the newly created device or instance of software is sold; and
one or more computing devices configured to run a blockchain client application that communicates with the one or more servers to provide updates to the blockchain as to ownership and usage of devices or software, the blockchain client application configured to add a new transaction to the blockchain to specify a new owner identifier when a particular device or instance of software is sold and to specify when an update or change is made to a particular device or instance of software.

2. The system of claim 1, further comprising a plurality of devices and/or software configured with blockchain client interface software that enables communication with the blockchain software running on the one or more servers so as to add a new transaction in the blockchain when an update or change is made to the device or software.

3. The system of claim 2, wherein the blockchain client interface software is configured to regularly create a new transaction on the blockchain, the new transaction indicating an asset identifier and owner identifier for the associated device or software, and wherein the one or more servers running the blockchain software are configured to evaluate the new transaction to determine whether the device or software is still being used by a registered owner.

4. The system of claim 2, wherein the one or more servers are configured to send a validation response to the blockchain client interface software indicating whether or not the associated device or software is permitted to continue normal operation based on whether the device or software is being used by a registered owner.

5. The system of claim 2, wherein the one or more servers are owned or controlled by one or more entities designated to have permission to run the blockchain software for the blockchain, and the one or more computing devices are associated with one or more registered users that are designated to have permission to add blocks to the blockchain via the blockchain client application.

6. The system of claim 4, further comprising a database that stores a list of registered users that are permitted to own devices or software of a manufacturer and to enter transactions on the blockchain via the one or more computing devices.

7. The system of claim 1, wherein a transaction in the blockchain includes data that is secured using a private key associated with an owner of a device or instance of software, wherein the data that is secured includes usage data that pertains to how the device or software is used, or changes or updates to the device or software.

8. The system of claim 1, wherein the one or more servers configured to execute the blockchain software for the blockchain are configured to receive a request that includes an asset identifier for a particular device or instance of software to evaluate data contained in one or more blocks in the blockchain for the particular device or instance of software in order to determine whether the particular device or instance of software is eligible for support services.

9. The system of claim 1, wherein the one or more servers that run the blockchain software for the blockchain include a first set of one or more servers that reside in a first network, and a second set of one or more servers that reside in a second network, wherein the first set of one or more servers run one or more blockchains that track a first class of transactions associated with usage information for the particular device or instance of software and the second set of one or more servers run one or more blockchains that track a second class of transactions associated with usage information for the particular device or instance of software.

10. The system of claim 9, wherein the first set of one or more servers are in communication with the second set of one or more servers so as to link a transaction pertaining to the particular device or instance of software between a blockchain running on the first set of one or more servers and a blockchain running on the second set of one or more servers.

11. The system of claim 9, wherein at least one server of the second set of one or more servers is in communication with the particular device or instance of software to receive validation requests from the particular device or instance of software and send transaction validation responses to the particular device or instance of software.

12. The system of claim 9, wherein the first class of transactions are globally relevant transactions associated with usage of the particular device or instance of software and the second class of transactions are locally relevant transactions associated with usage of the particular device or instance of software, and wherein the second set of one or more servers send validation requests to the first set of one or more servers when a change for the particular device or instance of software is a globally relevant transaction.

13. A computer-implemented method comprising:
running a blockchain on one or more servers configured track ownership and usage of devices or software, such that each transaction in the blockchain includes an asset identifier that identifies a particular device or instance of software and an owner identifier that identifies a particular owner of a particular device or instance of software;
generating a new transaction in the blockchain for a newly created device or instance of software and including an asset identifier for the newly created device or instance of software together with an owner identifier to whom the newly created device or instance of software is sold;
receiving from a blockchain client application running on one or more computing devices that communicates with the one or more servers updates as to ownership and usage of devices or software; and
adding a new transaction to the blockchain to specify a new owner identifier when a particular device or instance of software is sold and to specify when an update or change is made to a particular device or instance of software.

14. The method of claim 13, further comprising:
regularly creating a new transaction on the blockchain, the new transaction indicating an asset identifier and owner identifier for the associated device or software;
evaluating the new transaction to determine whether the device or software is still being used by a registered owner; and
sending a validation response indicating whether or not the associated device or software is permitted to continue normal operation based on whether the device or software is being used by a registered owner.

15. The method of claim 14, wherein running a blockchain includes:
running one or more blockchains on a first set of one or more servers to track a first class of transactions associated with usage information for the particular device of instance of software; and
running one or more blockchains on a second set of one or more servers to track a first class of transactions associated with the usage information for particular device of instance of software.

16. The method of claim 15, further comprising:
communicating between the first set of one or more servers and the second set of one or more servers so as to link a transaction pertaining to the particular device or instance of software between a blockchain running on the first set of one or more servers and a blockchain running on the second set of one or more servers.

17. One or more computer readable storage media encoded with software comprising computer executable instructions and when the software is executed operable to perform operations comprising:
running a blockchain on one or more servers configured track ownership and usage of devices or software, such that each transaction in the blockchain includes an asset identifier that identifies a particular device or instance of software and an owner identifier that identifies a particular owner of a particular device or instance of software;
generating a new transaction in the blockchain for a newly created device or instance of software and including an asset identifier for the newly created device or instance of software together with an owner identifier to whom the newly created device or instance of software is sold;
receiving from a blockchain client application running on one or more computing devices that communicates with the one or more servers updates as to ownership and usage of devices or software; and
adding a new transaction to the blockchain to specify a new owner identifier when a particular device or instance of software is sold and to specify when an update or change is made to a particular device or instance of software.

18. The non-transitory computer readable storage media of claim 17, further comprising instructions for:
regularly creating a new transaction on the blockchain, the new transaction indicating an asset identifier and owner identifier for the associated device or software;
evaluating the new transaction to determine whether the device or software is still being used by a registered owner; and
sending a validation response indicating whether or not the associated device or software is permitted to continue normal operation based on whether the device or software is being used by a registered owner.

19. The non-transitory computer readable storage media of claim 17, further comprising instructions operable for:
running one or more blockchains on a first set of one or more servers to track a first class of transactions associated with usage information for the particular device of instance of software; and
running one or more blockchains on a second set of one or more servers to track a first class of transactions associated with the usage information for particular device of instance of software.

20. The non-transitory computer readable storage media of claim 19, wherein the first class of transactions track matters including feature license of the particular device or instance of software and the second class of transactions track matters including geographical location of the particular device or instance of software, and wherein the second set of one or more servers send validation requests to the first set of one or more servers when a change for the particular device or instance of software concerns matters of feature license.
